(19) United States
(12) Patent Application Publication
(10) Pub. No.: US 2014/0266998 A1
(43) Pub. Date: Sep. 18, 2014

(54) DRIVING METHOD FOR ELECTROOPTICAL DEVICE, DRIVING DEVICE FOR ELECTROOPTICAL DEVICE, ELECTROOPTICAL DEVICE AND ELECTRONIC DEVICE

(71) Applicant: Seiko Epson Corporation, Tokyo (JP)

(72) Inventors: Hideki OGAWA, Fujimi-machi (JP); Keitaro FUJIMORI, Fujimi-machi (JP)

(21) Appl. No.: 14/196,280

(22) Filed: Mar. 4, 2014

(30) Foreign Application Priority Data
Mar. 13, 2013 (JP) 2013-050106

(51) Int. Cl. G09G 3/34

(52) U.S. Cl. CPC G09G 3/344
USPC 345/107

(57) ABSTRACT

A driving method for an electrophoretic display device composed of a pixel electrode, an opposing electrode, and electrophoretic elements includes a color setting step and a DC resetting step. The electrophoretic elements are disposed between the pixel electrode and the opposing electrode and include a plurality of electrophoretic particles. In the color setting step, the plurality of electrophoretic particles are set in a first state by applying one or more types of driving voltages between the pixel electrode and the opposing electrode. In the DC resetting step, driving voltages for resetting an integral value of the driving voltages with respect to a driving time period in the color setting step are applied between the pixel electrode and the opposing electrode.

### CROSS-REFERENCE TO RELATED APPLICATIONS

This application claims priority to Japanese Patent Application No. 2013-050106 filed on Mar. 13, 2013. The entire disclosure of Japanese Patent Application No. 2013-050106 is hereby incorporated herein by reference.

### BACKGROUND

1. Technical Field

The present invention relates to a driving method for an electrooptical device, a driving device for an electrooptical device, an electrooptical device, an electronic device, and the like.

2. Related Art

An electrophoretic display device is known as one example of an electrooptical device. An electrophoretic display device is configured such that electrophoretic elements including pigmented electrophoretic particles are held between a pixel electrode and an opposing electrode. The electrophoretic display device displays an image by causing the electrophoretic particles to migrate through application of a voltage between these two electrodes. At this time, in the electrophoretic display device, the color of the displayed image can be changed by, for example, controlling the electrophoretic particles pigmented in different colors to migrate independently on a per-color basis. The electrophoretic elements are composed of, for example, a plurality of microcapsules that are sealed between the pixel electrode and the opposing electrode. Every microcapsule includes a plurality of electrophoretic particles.

Technology related to such an electrophoretic display device is disclosed in, for instance, the following examples of related art: JP-A-2009-258735 and N. Hiji, “Novel Color Electrophoretic E-Paper Using Independently Movable Colored Particles”, SID 2012 8.4 (hereinafter, simply “Hiji”).

JP-A-2009-258735 discloses a method whereby data of driving waveforms corresponding to transition in data of pixels is held in the form of a lookup table, data of a driving waveform corresponding to a result of comparison between image data of a current image and image data of the next image is retrieved from the lookup table, and a relevant pixel is driven based on the retrieved data of the driving waveform.

Hiji discloses a method whereby, after resetting the luminance by drawing all electrophoretic particles that have different thresholds toward an electrode on an image display side prior to driving of pixels, pixel colors are displayed by drawing the electrophoretic particles of respective colors toward desired electrodes.

However, with the method disclosed in JP-A-2009-258735, the more the gradations of pixels, the more the pairs of image data of a current image and image data of the next image. This gives rise to the problem that the amount of data of driving waveforms to be prestored in the lookup table becomes enormous. For example, in the case where R, G and B color components are each reproduced with 4 bits per pixel, 2⁴×2⁴×2⁴=4,069 gradations can be reproduced. Therefore, the lookup table needs to include 4,096 (gradations of the current image)×4,096 (gradations of the next image)=16,777,216 reference addresses.

In this respect, the method disclosed in Hiji resets the luminance prior to driving of pixels, and therefore can reduce the gradations of the current image to one gradation. This enables a significant reduction in the number of reference addresses for referring to the lookup table. For example, in the case where R, G and B color components are each reproduced with 4 bits per pixel, it suffices for the lookup table to include 1 (gradation of the current image)×4,096 (gradations of the next image)=4,096 reference addresses.

However, a problem with the method disclosed in Hiji is that, when resetting the luminance, the balance of an integral value of voltages applied to electrophoretic particles with respect to a time period (DC balance) is lost. Unlike electrophoretic particles with a proper DC balance, migration of electrophoretic particles with a DC balance deviated to the negative or positive side triggers an unintended movement of the electrophoretic particles due to, for example, dependence on the polarity of applied voltages. Therefore, if the driving of pixels is repeated while the DC balance is lost, a problem arises in that long-term reliability is adversely affected. For example, even when pixel colors are displayed using specified data of driving waveforms, color shift becomes visible.

### SUMMARY

An advantage of some aspects of the invention enables provision of a driving method for an electrooptical device, a driving device for an electrooptical device, an electrooptical device, an electronic device, and the like that can secure long-term reliability.

(1) In a first aspect of the invention, a driving method for an electrooptical device composed of a first electrode, a second electrode, and electrophoretic elements includes a state setting step and a DC resetting step. The electrophoretic elements are disposed between the first electrode and the second electrode and have a plurality of electrophoretic particles. In the state setting step, the plurality of electrophoretic particles are set in a first state by applying one or more types of driving voltages between the first electrode and the second electrode. In the DC resetting step, driving voltages for resetting an integral value of the driving voltages with respect to a driving time period in the state setting step are applied between the first electrode and the second electrode.

According to the first aspect, in the electrooptical device composed of the electrophoretic elements that have the plurality of electrophoretic particles, the DC resetting step is executed after setting the plurality of electrophoretic particles in the first state by applying one or more types of driving voltages. In the DC resetting step, between the first electrode and the second electrode, the driving voltages for resetting the integral value of the driving voltages that were applied to the plurality of electrophoretic particles to set the plurality of electrophoretic particles in the first state with respect to the driving time period therefor are applied. In this way, the DC balance of the electrophoretic particles, which is lost after setting the electrophoretic particles to the first state, can be restored, and long-term reliability can be ensured without triggering an unintended movement of the electrophoretic particles caused by, for example, dependence on the polarity of applied voltages.

(2) A second aspect of the invention is as follows. In the driving method for the electrooptical device according to the first aspect, provided that the integral value of the driving voltages with respect to the driving time period in the state setting step is W1 and an integral value of the driving voltages with respect to a driving time period in the DC resetting step is W2, W2=−W1.

According to the second aspect, the integral value of the driving voltages with respect to the driving time period in the DC resetting step is equal to and has an opposite polarity from the integral value of the driving voltages with respect to the driving time period in the state setting step. This makes it possible to reliably maintain the DC balance after the DC resetting step in addition to achieving the aforementioned effects.

(3) A third aspect of the invention is as follows. In the driving method for the electrooptical device according to the first or second aspect, the driving voltages applied between the first electrode and the second electrode in the DC resetting step are in a reverse order and have opposite polarities as compared to the one or more types of driving voltages applied in the state setting step.

According to the third aspect, the driving voltages applied between the first electrode and the second electrode in the DC resetting step are in the reverse order and have opposite polarities as compared to those applied in the state setting step. This makes it possible to restore the DC balance of the electrophoretic particles to zero through simple driving control in addition to achieving the aforementioned effects.

(4) A fourth aspect of the invention is as follows. In the driving method for the electrooptical device according to the first or second aspect, the driving voltages applied between the first electrode and the second electrode in the DC resetting step are in the same order and have opposite polarities as compared to the one or more types of driving voltages applied in the state setting step.

According to the fourth aspect, the driving voltages applied between the first electrode and the second electrode in the DC resetting step are in the same order and have opposite polarities as compared to those applied in the state setting step. This makes it possible to restore the DC balance of the electrophoretic particles to zero through simple driving control in addition to achieving the aforementioned effects.

(5) A fifth aspect of the invention is as follows. In the driving method for the electrooptical device according to any one of the first to fourth aspects, the DC resetting step is executed immediately before the state setting step for the next frame time period.

The fifth aspect makes it possible to reliably prevent setting of the state of the electrophoretic particles while the DC balance is lost, and to ensure long-term reliability.

(6) A sixth aspect of the invention is as follows. The driving method for the electrooptical device according to any one of the first to fifth aspects further includes a luminance resetting step of resetting the luminance after the DC resetting step.

According to the sixth aspect, the luminance resetting step is executed after the DC resetting step. Therefore, the luminance can be reset while the DC balance is maintained. This makes it possible to significantly reduce the scale of a lookup table that is referred to in rewriting pixels in addition to achieving the aforementioned effects.

(7) A seventh aspect of the invention is as follows. In the driving method for the electrooptical device according to the sixth aspect, in the luminance resetting step, after a first driving voltage having a first polarity is applied between the first electrode and the second electrode over a first time period, the first driving voltage having a second polarity that is opposite from the first polarity is applied between the first electrode and the second electrode over the first time period.

According to the seventh aspect, in the luminance resetting step, the first driving voltage is applied between the first electrode and the second electrode over time periods of the same length. Here, the first driving voltage applied over one time period has an opposite polarity from the first driving voltage applied over another time period. This makes it possible to reliably draw the electrophoretic particles toward one of the first electrode and the second electrode after reliably drawing the electrophoretic particle toward the other of the first electrode and the second electrode. Therefore, in the luminance resetting step, the luminance of pixels can be reliably set to a predetermined state.

(8) An eighth aspect of the invention is as follows. In the driving method for the electrooptical device according to any one of the first to seventh aspects, the plurality of electrophoretic particles have different thresholds. Here, thresholds denote values of driving voltages that serve as indication of a large change in mobilities of the electrophoretic particles upon change in driving voltages.

According to the eighth aspect, the electrophoretic particles have different thresholds indicating the start of migration. This makes it possible to control the electrophoretic particles to migrate independently on a per-threshold basis in accordance with values of driving voltages. With the use of independently controllable electrophoretic particles, even in the case where display of various colors and gradations causes loss of the DC balance, the DC balance can be restored and visible color shift can be prevented. Therefore, long-term reliability can be ensured.

(9) In a ninth aspect of the invention, a driving device for an electrooptical device composed of a first electrode, a second electrode, and electrophoretic elements includes a state setting unit and a DC resetting unit. The electrophoretic elements are disposed between the first electrode and the second electrode and have a plurality of electrophoretic particles. The state setting unit sets the plurality of electrophoretic particles in a first state by applying one or more types of driving voltages between the first electrode and the second electrode. The DC resetting unit applies, between the first electrode and the second electrode, driving voltages for resetting an integral value of the driving voltages applied by the state setting unit with respect to a driving time period therefor.

According to the ninth aspect, in the electrooptical device composed of the electrophoretic elements that have the plurality of electrophoretic particles, the DC resetting unit DC resets after setting the plurality of electrophoretic particles in the first state by applying one or more types of driving voltages. The DC resetting unit applies, between the first electrode and the second electrode, the driving voltages for resetting the integral value of the driving voltages that were applied to the plurality of electrophoretic particles to set the plurality of electrophoretic particles in the first state with respect to the driving time period therefor. In this way, the DC balance of the electrophoretic particles, which is lost after setting the electrophoretic particles to the first state, can be restored, and long-term reliability can be ensured without triggering an unintended movement of the electrophoretic particles caused by, for example, dependence on the polarity of applied voltages.

(10) A tenth aspect of the invention is as follows. In the driving device for the electrooptical device according to the ninth aspect, the driving voltages applied by the DC resetting unit between the first electrode and the second electrode are in a reverse order and have opposite polarities as compared to the one or more types of driving voltages applied by the state setting unit.

According to the tenth aspect, the driving voltages applied by the DC resetting unit between the first electrode and the second electrode are in a reverse order and have opposite polarities as compared to those applied by the state setting unit. This makes it possible to restore the DC balance of the electrophoretic particles to zero through simple driving control in addition to achieving the aforementioned effects.

(11) An eleventh aspect of the invention is as follows. In the driving device for the electrooptical device according to the ninth aspect, the driving voltages applied by the DC resetting unit between the first electrode and the second electrode are in the same order and have opposite polarities as compared to the one or more types of driving voltages applied by the state setting unit.

According to the eleventh aspect, the driving voltages applied by the DC resetting unit between the first electrode and the second electrode are in the same order and have opposite polarities as compared to those applied by the state setting unit. This makes it possible to restore the DC balance of the electrophoretic particles to zero through simple driving control in addition to achieving the aforementioned effects.

(12) In a twelfth aspect of the invention, an electrooptical device includes: the first electrode; the second electrode; electrophoretic elements that are disposed between the first electrode and the second electrode and have a plurality of electrophoretic particles; and the driving device for the electrooptical device according to any one of the ninth to eleventh aspects.

The twelfth aspect makes it possible to restore the DC balance of the electrophoretic particles, which is lost after setting the electrophoretic particles to the first state, and to provide a driving device for an electrooptical device that can ensure long-term reliability of the electrooptical device.

(13) In a thirteenth aspect of the invention, an electronic device includes the electrooptical device according to the twelfth aspect.

The thirteenth aspect makes it possible to restore the DC balance of the electrophoretic particles, which is lost after setting the electrophoretic particles to the first state, and to provide an electronic device that uses an electrooptical device with ensured long-term reliability. In this way, long-term reliability of the electronic device can also be ensured.

### BRIEF DESCRIPTION OF THE DRAWINGS

The invention will be described with reference to the accompanying drawings, wherein like numbers reference like elements.

FIG. 1 is a block diagram showing an example of a configuration of an electrophoretic display device according to a first embodiment of the invention.

FIG. 2 shows an example of an equivalent circuit representing electrical configurations of pixels in FIG. 1.

FIG. 3 shows a general configuration of a microcapsule composing electrophoretic elements according to the first embodiment.

FIG. 4 is an explanatory diagram showing the operations of the electrophoretic display device according to the first embodiment.

FIG. 5 is an explanatory diagram showing the operations of the electrophoretic display device according to the first embodiment.

FIG. 6 shows an example of a flow of a driving method for the electrophoretic display device according to the first embodiment.

FIG. 7 shows an example of a driving sequence of the electrophoretic display device according to the first embodiment.

FIG. 8 shows another example of a driving sequence of the electrophoretic display device according to the first embodiment.

FIG. 9 shows a general configuration of a microcapsule composing electrophoretic elements according to a second embodiment.

FIG. 10 is an explanatory diagram showing thresholds for electrophoretic particles according to the second embodiment.

FIG. 11 is an explanatory diagram showing the operations of an electrophoretic display device according to the second embodiment.

FIG. 12 is an explanatory diagram showing the operations of the electrophoretic display device according to the second embodiment.

FIG. 13 is an explanatory diagram showing the operations of the electrophoretic display device according to the second embodiment.

FIG. 14 shows an example of a driving sequence of the electrophoretic display device according to the second embodiment.

FIG. 15 shows another example of a driving sequence of the electrophoretic display device according to the second embodiment.

FIG. 16 shows a general configuration of a microcapsule composing electrophoretic elements according to a third embodiment.

FIG. 17 is an explanatory diagram showing thresholds for electrophoretic particles according to the third embodiment.

FIG. 18 is an explanatory diagram showing the operations of an electrophoretic display device according to the third embodiment.

FIG. 19 is an explanatory diagram showing the operations of the electrophoretic display device according to the third embodiment.

FIG. 20 is an explanatory diagram showing the operations of the electrophoretic display device according to the third embodiment.

FIG. 21 is an explanatory diagram showing the operations of the electrophoretic display device according to the third embodiment.

FIG. 22 shows an example of a driving sequence of the electrophoretic display device according to the third embodiment.

FIG. 23 shows another example of a driving sequence of the electrophoretic display device according to the third embodiment.

FIG. 24 is a block diagram showing an example of a configuration of an electronic device including an electrophoretic display device according to one of the first to third embodiments.

### DESCRIPTION OF EXEMPLARY EMBODIMENTS

The following describes embodiments of the invention in detail with reference to the drawings. It should be noted that the embodiments described below are not intended to unreasonably limit the contents of the invention described in the attached claims. Furthermore, not all configurations described below are constituent elements indispensable for achieving the advantage of the invention.

Electrooptical Device

The following embodiments describe an electrophoretic display device adopting an active matrix driving method as one example of an electrooptical device according to the invention. However, the electrooptical device according to the invention is by no means limited to the electrophoretic display device adopting the active matrix driving method.

### 1. First Embodiment

FIG. 1 is a block diagram showing an example of a configuration of an electrophoretic display device serving as an electrooptical device according to a first embodiment of the invention.

In an electrophoretic display device 10 according to the first embodiment, pixels include display elements that have a function of a memory. The property of the electrophoretic display device 10 is such that, when a display state is not updated, a previous display state is retained. The electrophoretic display device 10 includes a pixel region 12, a controller 20, a scan line driving circuit 30, a data line driving circuit 40, and a common electrode driving circuit 50. A part or all of the scan line driving circuit 30, the data line driving circuit 40, and the common electrode driving circuit 50 function as a driving device for the electrophoretic display device 10. The pixel region 12 in FIG. 1 may serve as an electrophoretic display device, with the controller 20, the scan line driving circuit 30, the data line driving circuit 40, and the common electrode driving circuit 50 provided outside the electrophoretic display device.

The pixel region 12 includes a plurality of pixels P11 to Pn1, P12 to Pn2, . . . , P1m to Pnm arrayed in a matrix of m rows×n columns (m and n both being an integer equal to or greater than two). The plurality of pixels P11 to Pn1, P12 to Pn2, . . . , P1m to Pnm are configured in the same manner. In the pixel region 12, scan lines Y1 to Ym and data lines X1 to Xn are arranged such that the former and the latter intersect each other. More specifically, in the pixel region 12 are arranged m scan lines Y1 to Ym which extend in an X direction and line up in a Y direction, as well as n data lines X1 to Xn which extend in the Y direction and line up in the X direction. The pixels are arranged in one-to-one correspondence with intersections between the scan lines and the data lines.

The controller 20 controls the operations of the scan line driving circuit 30, the data line driving circuit 40, and the common electrode driving circuit 50. More specifically, in order to realize a desired display state, the controller 20 supplies timing signals, such as clock signals and start pulse signals, to the scan line driving circuit 30, the data line driving circuit 40, and the common electrode driving circuit 50.

Under control of the controller 20, the scan line driving circuit 30 sequentially supplies scan signals, which are pulse signals, to the scan lines Y1, Y2, . . . , Ym during a predetermined frame time period.

Under control of the controller 20, the data line driving circuit 40 supplies a data voltage to the data lines X1, X2, . . . , Xn. The data voltage is one of a reference voltage “GND” (e.g., 0 volts), a high-potential voltage “VSH” (e.g., +15 volts), and a law-potential voltage “−VSH” (e.g., −15 volts).

The common electrode driving circuit 50 supplies a common voltage Vcom (e.g., a voltage having the same electric potential as the reference voltage “GND”) to a common electrode line 52 that is electrically connected to opposing electrodes of the pixels. The common voltage Vcom may be a voltage different from the reference voltage “GND” as long as the opposing electrodes and pixel electrodes to which the reference voltage “GND” has been supplied have substantially the same electric potential. For example, the common voltage Vcom may have a different value from the reference voltage “GND” supplied to the pixel electrodes in consideration of fluctuations in the electric potential of the pixel electrodes due to AC coupling with other signal lines, electrodes, and the like.

FIG. 2 shows an example of an equivalent circuit representing electrical configurations of the pixels in FIG. 1. Components in FIG. 2 that are similar to those in FIG. 1 are given the same reference signs thereas, and a description thereof is omitted where appropriate. The pixels P11 to Pn1, P12 to Pn2, . . . , P1m to Pnm in FIG. 1 are configured in a similar manner. Therefore, the pixel P11 will be described below.

The pixel P11 includes a switching transistor 60, a pixel electrode 62, an opposing electrode 64, electrophoretic elements (electrooptical elements) 66, and a holding capacitor 68.

The switching transistor 60 is constituted by, for example, an N-type metal-oxide-semiconductor (MOS) transistor. In the switching transistor 60, a gate is electrically connected to the scan line Y1, a source is electrically connected to the data line X1, and a drain is electrically connected to the pixel electrode 62 and one end of the holding capacitor 68. The switching transistor 60 outputs a data voltage supplied via the data line X1 to the pixel electrode 62 and one end of the holding capacitor 68 at a timing corresponding to a scan signal supplied via the scan line Y1

The pixel electrode 62, which serves as a first electrode, is arranged so as to oppose the opposing electrode 64 via the electrophoretic elements 66. The data voltage is supplied to the pixel electrode 62 via the data line X1 and the switching transistor 60.

The opposing electrode 64, which serves as a second electrode, is electrically connected to the common electrode line 52 to which the common voltage Vcom is supplied. The opposing electrodes included in the respective pixels P11 to Pn1, P12 to Pn2, . . . , P1m to Pnm have the same electric potential. The opposing electrode 64 is formed from, for example, a transparent conductive material, such as magnesium-silver (MgAg), an indium tin oxide (ITC) film, and indium zinc oxide (TZO). An image is displayed on the side of the opposing electrode 64.

The electrophoretic elements 66 are disposed between the pixel electrode 62 and the opposing electrode 64 and form an electrophoretic layer. The electrophoretic elements 66 are composed of a plurality of microcapsules (broadly speaking, cells). Every microcapsule includes a plurality of electrophoretic particles that are charged and pigmented. That is to say, the electrophoretic display device 10 is a microcapsule-type electrophoretic display device.

The holding capacitor 68 includes a pair of electrodes that are arranged so as to oppose each other via a dielectric film. One electrode is electrically connected to the drain of the switching transistor 60 and the pixel electrode 62, while the other electrode is electrically connected to the common electrode line 52. The holding capacitor 68 can hold the data voltage supplied to the pixel electrode 62 for a predetermined time period.

FIG. 3 shows a general configuration of a microcapsule composing the electrophoretic elements 66 according to the first embodiment.

A microcapsule 70 according to the first embodiment includes an unpigmented viscous solvent 72, a plurality of electrophoretic particles 74 that are positively charged and pigmented in black, and a plurality of electrophoretic particles 76 that are negatively charged and pigmented in white. The electrophoretic particles 74 and 76 are held between the pixel electrode 62 and the opposing electrode 64, and migrate in the solvent 72 in accordance with a voltage between these electrodes.

FIGS. 4 and 5 are explanatory diagrams showing the operations of the electrophoretic display device 10 according to the first embodiment. FIGS. 4 and 5 schematically show partial cross sections of the pixel in FIG. 2. Specifically, FIG. 4 shows the state where the opposing electrode 64 is set at a higher electric potential than the pixel electrode 62, while FIG. 5 shows the state where the opposing electrode 64 is set at a lower electric potential than the pixel electrode 62. It should be noted that components in FIGS. 4 and 5 that are similar to those in FIGS. 2 and 3 are given the same reference signs thereas, and a description thereof is omitted where appropriate.

As shown in FIG. 4, when the opposing electrode 64 is set at a higher electric potential than the pixel electrode 62, the positively-charged black electrophoretic particles 74 are drawn toward the pixel electrode 62, whereas the negatively-charged white electrophoretic particles 76 are drawn toward the opposing electrode 64. At this time, white is recognized when viewed from the side of the opposing electrode 64.

On the other hand, as shown in FIG. 5, when the opposing electrode 64 is set at a lower electric potential than the pixel electrode 62, the positively-charged black electrophoretic particles 74 are drawn toward the opposing electrode 64, whereas the negatively-charged white electrophoretic particles 76 are drawn toward the pixel electrode 62. At this time, black is recognized when viewed from the side of the opposing electrode 64.

Meanwhile, when the opposing electrode 64 is set at substantially the same electric potential as the pixel electrode 62, the electrophoretic particles 74 and 76 in the microcapsule 70 do not migrate electrophoretically, and a previous display state is retained.

In the electrophoretic display device 10, by resetting the luminance through application of a predetermined voltage between the pixel electrode 62 and the opposing electrode 64 prior to display of pixels, the scale of a lookup table that is referred to for data of driving waveforms necessary for updating the pixels can be reduced. However, simply resetting the luminance gives rise to the problem of loss of the DC balance of the electrophoretic particles 74 and 76. The state where the DC balance is maintained is a state where an integral value of values of voltages applied to the electrophoretic particles with respect to a time period of voltage application is zero. On the other hand, the state where the DC balance is lost is a state where the integral value is positive or negative. While the DC balance is lost, the amounts of shifts in the DC balance are gradually accumulated. This triggers an unintended movement of the electrophoretic particles due to, for example, dependence on the polarity of applied voltages, thereby adversely affecting long-term reliability.

In view of this, in the first embodiment, after deciding on colors of pixels by placing the electrophoretic particles 74 and 76 in a desired state (first state) through application of a voltage, a voltage is applied to the pixels so as to restore the state where the DO balance is maintained.

FIG. 6 shows an example of a flow of a driving method for the electrophoretic display device 10 according to the first embodiment. The following flow is realized by, for example, the controller 20 controlling the scan line driving circuit 30, the data line driving circuit 40, and the common electrode driving circuit 50.

First, the controller 20 monitors power-on of the electrophoretic display device 10 (step S1: N). If the power-on has been detected (step S1: Y), the controller 20 proceeds to a luminance resetting phase as a luminance resetting step and controls the scan line driving circuit 30, the data line driving circuit 40, and the common electrode driving circuit 50 (step S2). In the luminance resetting phase, the scan line driving circuit 30, the data line driving circuit 40, and the common electrode driving circuit 50 apply driving voltages for displaying black between the pixel electrode 62 and the opposing electrode 64 over a time period TO (first time period). Thereafter, the scan line driving circuit 30, the data line driving circuit 40, and the common electrode driving circuit 50 apply driving voltages for displaying white between the pixel electrode 62 and the opposing electrode 64 over the time period TO. The driving voltages for displaying black are negative (first polarity) driving voltages “−VSH” (first driving voltages), whereas the driving voltages for displaying white are positive (second polarity) driving voltages “+VSH” (second driving voltages).

Next, the controller 20 proceeds to a color setting phase as a state setting step and controls the scan line driving circuit 30, the data line driving circuit 40, and the common electrode driving circuit 50 (step S3). In the color setting phase, colors of pixels are set by the scan line driving circuit 30, the data line driving circuit 40, and the common electrode driving circuit 50 setting the plurality of electrophoretic particles 74 and 76 in a predetermined state through application of one or more types of driving voltages between the pixel electrode 62 and the opposing electrode 64.

Then, the controller 20 proceeds to a DC resetting phase as a DC resetting step and controls the scan line driving circuit 30, the data line driving circuit 40, and the common electrode driving circuit 50 (step S4). In the DC resetting phase, the scan line driving circuit 30, the data line driving circuit 40, and the common electrode driving circuit 50 apply, between the pixel electrode 62 and the opposing electrode 64, one or more types of driving voltages for resetting an integral value of the driving voltages with respect to a driving time period in step S3 for a predetermined time period. It should be noted that resetting the integral value denotes restoring the integral value to a default value, that is to say, zero. More specifically, in the DC resetting phase, provided that the integral value of the driving voltages with respect to the driving time period in step S3 is W1 and an integral value of the driving voltages with respect to a driving time period in step S4 is W2, the driving voltages are applied between the pixel electrode 62 and the opposing electrode 64 so as to satisfy the relationship W2=−W1.

Subsequently, when displaying an image of the next frame time period (step S5: Y), the controller 20 returns to step S2, that is to say, proceeds to the luminance resetting phase, and controls the scan line driving circuit 30, the data line driving circuit 40, and the common electrode driving circuit 50. In other words, the DC resetting phase is executed immediately before the luminance resetting phase for the next frame time period. It is preferable that, in step S2, the time period T0 in the luminance resetting phase immediately after the power-on be longer than a time period T1 in the luminance resetting phase that is executed to display an image of the next frame time period.

In FIG. 6, the luminance resetting phase is set immediately before the color setting phase. However, if the luminance resetting phase is not executed, it is preferable that the DC resetting phase be executed immediately before the color setting phase for the next frame time period. In this way, colors are not set while the DC balance is lost, and therefore long-term reliability can be ensured.

If the image of the next frame time period is not displayed in step S5 (step S5: N) and the sequence of processing is not ended (step S6: N), the controller 20 returns to step S5 and continues the processing.

If the processing is ended in step S6 (step S6: Y), the controller 20 ends the sequence of processing (end).

The scan line driving circuit 30, the data line driving circuit 40, and the common electrode driving circuit 50 may include luminance resetting units that realize the luminance resetting phase. Furthermore, the scan line driving circuit 30, the data line driving circuit 40, and the common electrode driving circuit 50 may include color setting units (state setting units) that realize the color setting phase. Moreover, the scan line driving circuit 30, the data line driving circuit 40, and the common electrode driving circuit 50 may include DC resetting units that realize the DC resetting phase.

FIG. 7 shows an example of a driving sequence of the electrophoretic display device 10 according to the first embodiment. FIG. 7 focuses on a driving sequence for one pixel. In FIG. 7, a vertical axis represents a voltage between the pixel electrode 62 and the opposing electrode 64, while a horizontal axis represents time. In FIG. 7, for the sake of explanation, selection time periods for this pixel in the respective frame time periods are illustrated side by side, and the length of every selection time period is indicated as 1T.

In the case where white is a reference color, after the power-on, the scan line driving circuit 30, the data line driving circuit 40, and the common electrode driving circuit 50 reset the luminance while the DC balance is maintained as the luminance resetting phase. During a time period TO that makes up the first half of this luminance resetting phase, the driving voltages for displaying black are applied, and the integral value of the driving voltages with respect to the driving time period is −VSH×Q×1T (T0=Q×1T). During a time period T0 that makes up the second half, the driving voltages for displaying white are applied, and the integral value is +VSH×Q×1T. That is to say, at time B1 marking the end of the luminance resetting phase, a sum of the integral values is zero, and the DC balance is maintained due to display of white. Here, Q denotes a natural number corresponding to the length of the time period T0.

Thereafter, the scan line driving circuit 30, the data line driving circuit 40, and the common electrode driving circuit 50 display a color CA (first color) by applying one or more driving voltages between the pixel electrode 62 and the opposing electrode 64 over multiple selection time periods as the color setting phase. The integral value of the driving voltages with respect to the driving time period in this color setting phase is −VSH×4T+VSH×2T−VSH×1T=−3VSH×1T. That is to say, at time B2 marking the end of the color setting phase, the DC balance has been lost and moved to the negative side due to display of the color CA.

Next, the scan line driving circuit 30, the data line driving circuit 40, and the common electrode driving circuit 50 restore the DC balance to zero by applying one or more driving voltages between the pixel electrode 62 and the opposing electrode 64 over multiple selection time periods as the DC resetting phase. In this DC resetting phase, the driving voltages applied between the pixel electrode 62 and the opposing electrode 64 are in the reverse order and have opposite polarities as compared to those applied in the color setting phase. The integral value of the driving voltages with respect to the driving time period in this DC resetting phase is +VSH×1T−VSH×2T+VSH×4T=+3VSH×1T. That is to say, at time B3 marking the end of the DC resetting phase, the DC balance is maintained due to display of the color CA′.

It will be assumed that an image of the next frame time period is displayed continuously. At time B3 marking the end of the DC resetting phase, the luminance is not reset unless characteristics of migration of the electrophoretic particles 74 and 76 relative to time are in a linear relationship. Therefore, the scan line driving circuit 30, the data line driving circuit 40, and the common electrode driving circuit 50 reset the luminance while DC balance is maintained as the luminance resetting phase. During a time period T1 that makes up the first half of this luminance resetting phase, the driving voltages for displaying black are applied, and the integral value of the driving voltages with respect to the driving time period is −VSH×6T. During a time period T1 that makes up the second half, the driving voltages for displaying white are applied, and the integral value is +VSH×6T. That is to say, at time B4 marking the end of the luminance resetting phase, a sum of the integral values is zero, and the DC balance is maintained due to display of white. Note that T1=T0 may hold in this luminance resetting phase.

Thereafter, the scan line driving circuit 30, the data line driving circuit 40, and the common electrode driving circuit 50 display a color CB (second color) by applying one or more driving voltages between the pixel electrode 62 and the opposing electrode 64 over multiple selection time periods again as the color setting phase. That is to say, at time B5 marking the end of the color setting phase, the DC balance has been lost and moved to the negative side due to display of the color CB. Thereafter, the DC resetting phase is executed in a similar manner.

In the first embodiment, the driving voltages applied in the DC resetting phase are in the reverse order as compared to those applied in the color setting phase. However, in the DC resetting phase, it is sufficient to offset the integral value of the driving voltages with respect to the driving time period in the color setting phase.

FIG. 8 shows another example of a driving sequence of the electrophoretic display device 10 according to the first embodiment. Components in FIG. 8 that are similar to those in FIG. 7 are given the same reference signs thereas, and a description thereof is omitted where appropriate.

The driving sequence of FIG. 8 differs from the driving sequence of FIG. 7 in the DC resetting phase. More specifically, in the driving sequence of FIG. 8, driving voltages applied between the pixel electrode 62 and the opposing electrode 64 in the DC resetting phase are in the same order and have opposite polarities as compared to those applied in the color setting phase. The integral value of the driving voltages with respect to the driving time period in this DC resetting phase is VSH×4T−VSH×2T+VSH×1T=+3VSH×1T. That is to say, at time B3′ marking the end of the DC resetting phase, the DC balance is maintained due to display of the color CA′.

As described above, in the first embodiment, the presence of the DC resetting phase makes it possible to maintain the DC balance of electrophoretic particles, which is lost after setting colors (gradations) to pixels. Therefore, long-term reliability can be ensured. Furthermore, as the luminance is reset while the DC balance is maintained in the luminance resetting phase, the scale of a lookup table that is referred to in rewriting pixels can be significantly reduced.

### 2. Second Embodiment

The first embodiment has described the example in which the microcapsule 70 includes the solvent 72 and the electrophoretic particles 74 and 76, and control is performed using two types of driving voltages. However, embodiments of the invention are not limited in this way. In a second embodiment, a microcapsule includes a solvent and a plurality of electrophoretic particles with different thresholds, and control is performed using four types of driving voltages. For the sake of explanation, the following describes portions of the second embodiment that are different from the first embodiment.

FIG. 9 shows a general configuration of a microcapsule composing the electrophoretic elements according to the second embodiment. In the second embodiment, the electrophoretic elements 66 of FIG. 2 are composed of a microcapsule 170 shown in FIG. 9.

The microcapsule 170 according to the second embodiment includes an unpigmented viscous solvent 172, a plurality of electrophoretic particles 174 pigmented in black, and a plurality of electrophoretic particles 176 pigmented in white. The electrophoretic particles 174 and 176 are positively charged and have different thresholds. The electrophoretic particles 174 and 176 are held between the pixel electrode 62 and the opposing electrode 64, and migrate in the solvent 172 in accordance with a voltage between these electrodes.

Furthermore, in the second embodiment, the data line driving circuit supplies five types of data voltages to the data lines X1, X2, . . . , Xn under control of the controller 20, so as to control the electrophoretic particles with different thresholds. In the present case, a data voltage is one of a reference voltage “GND”, high-potential voltages “+V2”, “+V1” (V2=2×V1), and low-potential voltages “−V1”, “−V2”.

FIG. 10 is an explanatory diagram showing the thresholds for the electrophoretic particles 174 and 176 according to the second embodiment. FIG. 10 shows exemplary changes in the electrophoretic particles 174 and 176, with a vertical axis representing the particle position of the electrophoretic particles and a horizontal axis representing the electric field between the pixel electrode 62 and the opposing electrode 64, similarly to Hiji.

In FIG. 10, a negative threshold and a positive threshold for the electric field at which the electrophoretic particles 176 start to migrate toward one of the pixel electrode 62 and the opposing electrode 64 are indicated as “−Eth1” and “+Eth1”, respectively, and such characteristics are indicated as characteristics L1.

Similarly, a negative threshold and a positive threshold for the electric field at which the electrophoretic particles 174 start to migrate toward one of the pixel electrode 62 and the opposing electrode 64 are indicated as “−Eth2” and “+Eth2”, respectively (where 0<Eth1<Eth2), and such characteristics are indicated as characteristics L2.

FIGS. 11 to 13 are explanatory diagrams showing the operations of the electrophoretic display device according to the second embodiment. Components in FIGS. 11 to 13 that are similar to those in FIGS. 4, 5, and 9 are given the same reference signs thereas, and a description thereof is omitted where appropriate.

If an electric field “+E2”, which is further toward the positive side than the electric field “+Eth2”, is applied between the pixel electrode 62 and the opposing electrode 64, the electrophoretic particles 174 and 176 are drawn toward the opposing electrode 64 as shown in FIG. 11.

If electric fields “−E2” and “+E1” are applied in order between the pixel electrode 62 and the opposing electrode 64 in the state of FIG. 11, the electrophoretic particles 174 and 176 are first drawn toward the pixel electrode 62, and then the electrophoretic particles 176 are drawn toward the opposing electrode 64. As a result, as shown in FIG. 12, the electrophoretic particles 174 are drawn toward the pixel electrode 62, whereas the electrophoretic particles 176 are drawn toward the opposing electrode 64. At this time, white is recognized when viewed from the side of the opposing electrode 64.

On the other hand, if an electric field “−E1” is applied between the pixel electrode 62 and the opposing electrode 64 in the state of FIG. 11, the electrophoretic particles 176 are drawn toward the pixel electrode 62. As a result, as shown in FIG. 13, the electrophoretic particles 174 are drawn toward the opposing electrode 64, whereas the electrophoretic particles 176 are drawn toward the pixel electrode 62. At this time, black is recognized when viewed from the side of the opposing electrode 64.

Meanwhile, if an electric field that is equal to or further toward the positive side than an electric field “−E0” and further toward the negative side than an electric field “+E0” is applied between the pixel electrode 62 and the opposing electrode 64, the electrophoretic particles 174, 176 do not migrate, and a previous display state is retained.

FIG. 14 shows an example of a driving sequence of the electrophoretic display device according to the second embodiment. In FIG. 14, it is assumed that the electric fields “−E2”, “−E1”, “+E1”, and “+E2” respectively correspond to the driving voltages “−V2”, “−V1”, “+V1”, and “+V2” between the pixel electrode 62 and the opposing electrode 64. Components in FIG. 14 that are similar to those in FIG. 7 are given the same reference signs thereas, and a description thereof is omitted where appropriate.

After the power-on, the scan line driving circuit 30, the data line driving circuit 40, and the common electrode driving circuit 50 reset the luminance while the DC balance is maintained as the luminance resetting phase. Similarly to FIG. 7, at time B11 marking the end of the luminance resetting phase, a sum of integral values is zero, and the DC balance is maintained.

Thereafter, the scan line driving circuit 30, the data line driving circuit 40, and the common electrode driving circuit 50 display a color CA1 by applying one or more driving voltages between the pixel electrode 62 and the opposing electrode 64 over multiple selection time periods as the color setting phase. In the color setting phase, the state of the black electrophoretic particles 174 with thresholds having large absolute values is set first, and then the state of the white electrophoretic particles 176 with thresholds having smaller absolute values is set. The integral value of the driving voltages with respect to the driving time period in this color setting phase is −V2×4T+V1×2T−V1×1T=−7×V1×1T. That is to say, at time B12 marking the end of the color setting phase, the DC balance has been lost and moved to the negative side due to display of the color CA1.

Next, the scan line driving circuit 30, the data line driving circuit 40, and the common electrode driving circuit 50 restore the DC balance to zero by applying one or more driving voltages between the pixel electrode 62 and the opposing electrode 64 over multiple selection time periods as the DC resetting phase. The integral value of the driving voltages with respect to the driving time period in this DC resetting phase is +V1×1T−V1×2T+V2×4T=+7×V1×1T. That is to say, at time B13 marking the end of the DC resetting phase, the DC balance is maintained due to display of the color CA1″.

Subsequently, when displaying an image of the next frame time period, the scan line driving circuit 30, the data line driving circuit 40, and the common electrode driving circuit 50 reset the luminance while the DC balance is maintained as the luminance resetting phase. That is to say, at time B14 marking the end of the luminance resetting phase, the DC balance is maintained, similarly to FIG. 7.

Thereafter, the scan line driving circuit 30, the data line driving circuit 40, and the common electrode driving circuit 50 display a color CB1 by applying one or more driving voltages between the pixel electrode 62 and the opposing electrode 64 over multiple selection time periods again as the color setting phase. That is to say, at time B15 marking the end of the color setting phase, the DC balance has been lost and moved to, for example, the negative side due to display of the color CB1. Thereafter, the DC resetting phase is executed in a similar manner.

In the second embodiment, in the DC resetting phase, it is sufficient to offset the integral value of the driving voltages with respect to the driving time period in the color setting phase, similarly to the first embodiment.

FIG. 15 shows another example of a driving sequence of the electrophoretic display device according to the second embodiment. Components in FIG. 15 that are similar to those in FIG. 14 are given the same reference signs thereas, and a description thereof is omitted where appropriate.

The driving sequence of FIG. 15 differs from the driving sequence of FIG. 14 in the DC resetting phase. More specifically, in the driving sequence of FIG. 15, driving voltages applied between the pixel electrode 62 and the opposing electrode 64 in the DC resetting phase are in the same order and have opposite polarities as compared to those applied in the color setting phase. The integral value of the driving voltages with respect to the driving time period in this DC resetting phase is +V2×4T−V1×2T+V1×1T=+7×V1×1T. That is to say, at time B13′ marking the end of the DC resetting phase, the DC balance is maintained due to display of the color CA1′.

As described above, similarly to the first embodiment, the second embodiment makes it possible to restore the DC balance of electrophoretic particles, which is lost after setting colors to pixels, and to ensure long-term reliability. Furthermore, as the luminance is reset while the DC balance is maintained in the luminance resetting phase, the scale of a lookup table that is referred to in rewriting pixels can be significantly reduced.

### 3. Third Embodiment

Embodiments of the invention are not limited to the first or second embodiment. In a third embodiment, a microcapsule includes a solvent and a plurality of electrophoretic particles with different thresholds, and control is performed using eight types of driving voltages. For the sake of explanation, the following describes portions of the third embodiment that are different from the first embodiment.

FIG. 16 shows a general configuration of a microcapsule composing the electrophoretic elements according to the third embodiment. In the third embodiment, the electrophoretic elements 66 of FIG. 2 are composed of a microcapsule 270 shown in FIG. 16.

The microcapsule 270 according to the third embodiment includes a viscous solvent 272 pigmented in black, a plurality of electrophoretic particles 274 pigmented in red, a plurality of electrophoretic particles 276 pigmented in green, and a plurality of electrophoretic particles 278 pigmented in blue. The electrophoretic particles 274, 276, and 278 are positively charged and have different thresholds. The solvent 272 is composed of a plurality of uncharged particles pigmented in black. The electrophoretic particles 274, 276, and 278 are held between the pixel electrode 62 and the opposing electrode 64, and migrate in the solvent 272 in accordance with a voltage between these electrodes.

Furthermore, in the third embodiment, the data line driving circuit supplies nine types of data voltages to the data lines X1, X2, . . . Xn under control of the controller 20, so as to control the electrophoretic particles with different thresholds. In the present case, a data voltage is one of a reference voltage “GND”, high-potential voltages “+V4”, “+V3”, “+V2”, “+V1”, and low-potential voltages “−V1”, “−V2”, “−V3”, “−V4” It will be assumed that V4=4×V1, V3=3×V1, and V2=2×V1.

FIG. 17 is an explanatory diagram showing the thresholds for the electrophoretic particles 274, 276, and 278 according to the third embodiment. FIG. 17 shows exemplary changes in the electrophoretic particles 274, 276, 278, with a vertical axis indicating the particle position of the electrophoretic particles and a horizontal axis indicating the electric field between the pixel electrode 62 and the opposing electrode 64, similarly to Hiji.

In FIG. 17, a negative threshold and a positive threshold for the electric field at which the electrophoretic particles 274 start to migrate toward one of the pixel electrode 62 and the opposing electrode 64 are indicated as “−Ethr” and “+Ethr”, respectively, and such characteristics are indicated as characteristics Lr.

Similarly, a negative threshold and a positive threshold for the electric field at which the electrophoretic particles 276 start to migrate toward one of the pixel electrode 62 and the opposing electrode 64 are indicated as “−Ethg” and “+Ethg”, respectively (where 0<Ethg<Ethr), and such characteristics are indicated as characteristics Lg.

Furthermore, a negative threshold and a positive threshold for the electric field at which the electrophoretic particles 278 start to migrate toward one of the pixel electrode 62 and the opposing electrode 64 are indicated as “−Ethb” and “+Ethb”, respectively (where 0<Ethb<Ethg), and such characteristics are indicated as characteristics Lb.

FIGS. 18 to 21 are explanatory diagrams showing the operations of the electrophoretic display device according to the third embodiment. Components in FIGS. 18 to 21 that are similar to those in FIGS. 4, 5, and 16 are given the same reference signs thereas, and a description thereof is omitted where appropriate.

If an electric field “+E4”, which is further toward the positive side than the electric field “+Ethr”, is applied between the pixel electrode 62 and the opposing electrode 64, the electrophoretic particles 274, 276, and 278 are drawn toward the opposing electrode 64 as shown in FIG. 18. At this time, white is recognized when viewed from the side of the opposing electrode 64 due to additive color mixing of red, green, and blue.

On the other hand, if an electric field “−E4” is applied between the pixel electrode 62 and the opposing electrode 64 in the state of FIG. 18, the electrophoretic particles 274, 276, and 278 are drawn toward the pixel electrode 62. As a result, as shown in FIG. 19, the electrophoretic particles 274, 276, and 278 are drawn toward the pixel electrode 62. At this time, black, which is the color of the solvent 272, is recognized when viewed from the side of the opposing electrode 64.

Meanwhile, if an electric field “−E3” is applied between the pixel electrode 62 and the opposing electrode 64 in the state of FIG. 18, the electrophoretic particles 276 and 278 are drawn toward the pixel electrode 62. As a result, as shown in FIG. 20, the electrophoretic particles 274 are drawn toward the opposing electrode 64, whereas the electrophoretic particles 276 and 278 are drawn toward the pixel electrode 62. At this time, red is recognized when viewed from the side of the opposing electrode 64.

If electric fields “−E3” and “+E2” are applied in order between the pixel electrode 62 and the opposing electrode 64 in the state of FIG. 18, the electrophoretic particles 276 and 278 are first drawn toward the pixel electrode 62, and then the electrophoretic particles 278 are drawn toward the opposing electrode 64. As a result, as shown in FIG. 21, the electrophoretic particles 274 and 278 are drawn toward the opposing electrode 64, whereas the electrophoretic particles 276 are drawn toward the pixel electrode 62. At this time, magenta is recognized when viewed from the side of the opposing electrode 64 due to additive color mixing.

Furthermore, if an electric field that is equal to or further toward the positive side than an electric field “−E1” and further toward the negative side than an electric field “+E1” is applied between the pixel electrode 62 and the opposing electrode 64, the electrophoretic particles 274, 276, and 278 do not migrate, and a previous display state is retained.

FIG. 22 shows an example of a driving sequence of the electrophoretic display device according to the third embodiment. In FIG. 22, it is assumed that the electric fields “−E4” and “−E3” respectively correspond to the driving voltages “−V4” and “−V3” between the pixel electrode 62 and the opposing electrode 64. It is also assumed that the electric fields “−E2” and “−E1” respectively correspond to the driving voltages “−V2” and “−V1” between the pixel electrode 62 and the opposing electrode 64. It is also assumed that the electric fields “+E1” and “+E2” respectively correspond to the driving voltages “+V1” and “+V2” between the pixel electrode 62 and the opposing electrode 64. It is similarly assumed that the electric fields “+E3” and “+E4” respectively correspond to the driving voltages “+V3” and “+V4” between the pixel electrode 62 and the opposing electrode 64. Components in FIG. 22 that are similar to those in FIG. 7 are given the same reference signs thereas, and a description thereof is omitted where appropriate.

After the power-on, the scan line driving circuit 30, the data line driving circuit 40, and the common electrode driving circuit 50 reset the luminance while the DC balance is maintained as the luminance resetting phase. Similarly to FIG. 7, at time B21 marking the end of the luminance resetting phase, a sum of integral values is zero, and the DC balance is maintained.

Thereafter, the scan line driving circuit 30, the data line driving circuit 40, and the common electrode driving circuit 50 display a color CA2 by applying one or more driving voltages between the pixel electrode 62 and the opposing electrode 64 over multiple selection time periods as the color setting phase. In the color setting phase, the states of the electrophoretic particles of respective colors are set in order from the electrophoretic particles with thresholds having the largest absolute value. The integral value of the driving voltages with respect to the driving time period in this color setting phase is −V3×4T+V2×2T−V1×1T=−9×V1×1T. That is to say, at time B22 marking the end of the color setting phase, the DC balance has been lost and moved to the negative side due to display of the color CA2.

Next, the scan line driving circuit 30, the data line driving circuit 40, and the common electrode driving circuit 50 restore the DC balance to zero by applying one or more driving voltages between the pixel electrode 62 and the opposing electrode 64 over multiple selection time periods as the DC resetting phase. The integral value of the driving voltages with respect to the driving time period in this DC resetting phase is +V1×1T−V2×2T+V3×4T=+9×V1×1T. That is to say, at time B23 marking the end of the DC resetting phase, the DC balance is restored due to display of the color CA2′.

Subsequently, when displaying an image of the next frame time period, the scan line driving circuit 30, the data line driving circuit 40, and the common electrode driving circuit 50 reset the luminance while the DC balance is maintained as the luminance resetting phase. That is to say, at time B24 marking the end of the luminance resetting phase, the DC balance is maintained, similarly to FIG. 7.

Thereafter, the scan line driving circuit 30, the data line driving circuit 40, and the common electrode driving circuit 50 display a color CB2 by applying one or more driving voltages between the pixel electrode 62 and the opposing electrode 64 over multiple selection time periods again as the color setting phase. That is to say, at time B25 marking the end of the color setting phase, the DC balance has been lost and moved to, for example, the negative side due to display of the color CB2. Thereafter, the DC resetting phase is executed in a similar manner.

In the third embodiment, in the DC resetting phase, it is sufficient to offset the integral value of the driving voltages with respect to the driving time period in the color setting phase, similarly to the first and second embodiments.

FIG. 23 shows another example of a driving sequence of the electrophoretic display device according to the third embodiment. Components in FIG. 23 that are similar to those in FIG. 22 are given the same reference signs thereas, and a description thereof is omitted where appropriate.

The driving sequence of FIG. 23 differs from the driving sequence of FIG. 22 in the DC resetting phase. More specifically, in the driving sequence of FIG. 23, driving voltages applied between the pixel electrode 62 and the opposing electrode 64 in the DC resetting phase are in the same order and have opposite polarities as compared to those applied in the color setting phase. The integral value of the driving voltages with respect to the driving time period in this DC resetting phase is +V3×4T→V2×2T+V1×1T=+9×V1×1T. That is to say, at time B23′ marking the end of the DC resetting phase, the DC balance is restored due to display of the color CA2′.

As described above, similarly to the first or second embodiment, the third embodiment makes it possible to restore the DC balance of electrophoretic particles, which is lost after setting colors to pixels, and to ensure long-term reliability. Furthermore, as the luminance is reset while the DC balance is maintained in the luminance resetting phase, the scale of a lookup table that is referred to in rewriting pixels can be significantly reduced.

Electronic Device

The electrophoretic display devices according to the first to third embodiments can be applied to various types of electronic devices.

FIG. 24 is a block diagram showing an example of a configuration of an electronic device including an electrophoretic display device according to one of the first to third embodiments. An electronic device 300 includes a host 310, an electrophoretic display device 400 according to one of the first to third embodiments, a storage unit 320, an operation unit 330, and a communication unit 340.

The host 310 controls the operations of components of the electronic device 300, including the electrophoretic display device 400. More specifically, the host 310 controls the operations of the electrophoretic display device 400 by executing a program prestored in the storage unit 320 and the like. The storage unit 320 stores the program and data executed by the host 310, as well as image data corresponding to images displayed by the electrophoretic display device 400. This function of the storage unit 320 is realized by a read-only memory (ROM), a random-access memory (RAM), and the like. The operation unit 330 is used by a user to input various types of information, and realized by various types of buttons, a keyboard, and the like. The communication unit 340 executes processing for external communication, and receives, for example, image data corresponding to images displayed by the electrophoretic display device 400.

Various types of devices may be used as the electronic device 300, including an electronic card (a credit card, a loyalty card, and the like), an electronic paper, an electronic notebook, an electronic dictionary, a remote control, a timepiece, a mobile telephone, a personal digital assistant such as an electronic book reader, and a calculator.

The above has described a driving method for an electrooptical device, a driving device for an electrooptical device, an electrooptical device, an electronic device, and the like according to the invention based on one of the embodiments. However, the invention is not limited to one of the embodiments. For example, the invention can be implemented in various aspects without departing from the concept thereof, and the following modifications are possible.

(1) The invention is not limited to adopting the colors in which electrophoretic particles are pigmented, the polarities of the electric charge, the number of types of electrophoretic particles in a microcapsule, the number of types of driving voltages, the driving time period, and the like described in the embodiments. Furthermore, the invention is not limited to adopting the materials of the electrodes, solvent, and electrophoretic particles described in the embodiments.

(2) While the second or third embodiment has described the examples in which a plurality of electrophoretic particles with different thresholds are used, the invention is not limited in this way.

(3) The embodiments have described exemplary driving sequences for displaying colors. However, the invention is not limited in this way, and can be applied to cases where colors are displayed in other driving sequences.

(4) While the third embodiment has described the example in which a plurality of electrophoretic particles that are pigmented in R, G, and B and have different thresholds are used, the invention is not limited in this way. The embodiments of the invention may adopt electrophoretic elements including a plurality of electrophoretic particles that are pigmented in cyan, magenta, and yellow and have different thresholds. Alternatively, the embodiments of the invention may adopt electrophoretic elements including a plurality of electrophoretic particles that are pigmented in colors composing a plurality of other color components and have different thresholds.

(5) While the embodiments have described a microcapsule-type electrophoretic display device as an example of an electrophoretic display device serving as an electrooptical device, the invention is not limited in this way.

(6) While the embodiments have described the invention as a driving method for an electrooptical device, a driving device for an electrooptical device, an electrooptical device, an electronic device, and the like, the invention is not limited in this way. For example, the invention may be an electrophoretic display device and a driving method for an electrophoretic display device.

What is claimed is:

1. A driving method for an electrooptical device including a first electrode, a second electrode, and electrophoretic elements that are disposed between the first electrode and the second electrode and have a plurality of electrophoretic particles, comprising:
(a) setting the plurality of electrophoretic particles in a first state by applying one or more types of driving voltages between the first electrode and the second electrode; and
(b) applying, between the first electrode and the second electrode, driving voltages for resetting an integral value of the driving voltages with respect to a driving time period in (a).

2. The driving method for the electrooptical device according to claim 1, wherein
provided that the integral value of the driving voltages with respect: to the driving time period in (a) is W1 and an integral value of the driving voltages with respect to a driving time period in (b) is W2, W2=−W1.

3. The driving method for the electrooptical device according to claim 1, wherein
the driving voltages applied between the first electrode and the second electrode in (b) are in a reverse order and have opposite polarities as compared to the one or more types of driving voltages applied in (a).

4. The driving method for the electrooptical device according to claim 1, wherein
the driving voltages applied between the first electrode and the second electrode in (b) are in the same order and have opposite polarities as compared to the one or more types of driving voltages applied in (a).

5. The driving method for the electrooptical device according to claim 1, wherein
(b) is executed immediately before (a) for a next frame time period.

6. The driving method for the electrooptical device according to claim 1, further comprising
(c) resetting a luminance after (b).

7. The driving method for the electrooptical device according to claim 6, wherein
in (c), after a first driving voltage having a first polarity is applied between the first electrode and the second electrode over a first time period, the first driving voltage having a second polarity that is opposite from the first polarity is applied between the first electrode and the second electrode over the first time period.

8. The driving method for the electrooptical device according to claim 1, wherein
the plurality of electrophoretic particles have different thresholds.

9. A driving device for an electrooptical device including a first electrode, a second electrode, and electrophoretic element that are disposed between the first electrode and the second electrode and have a plurality of electrophoretic particles, comprising:
a state setting unit that sets the plurality of electrophoretic particles in a first state by applying one or more types of driving voltages between the first electrode and the second electrode; and
a DC resetting unit that applies, between the first electrode and the second electrode, driving voltages for resetting an integral value of the driving voltages applied by the state setting unit with respect to a driving time period therefor.

10. The driving device for the electrooptical device according to claim 9, wherein
the driving voltages applied by the DC resetting unit between the first electrode and the second electrode are in a reverse order and have opposite polarities as compared to the one or more types of driving voltages applied by the state setting unit.

11. The driving device for the electrooptical device according to claim 9, wherein
the driving voltages applied by the DC resetting unit between the first electrode and the second electrode are in the same order and have opposite polarities as compared to the one or more types of driving voltages applied by the state setting unit.

12. An electrooptical device comprising:
the first electrode;
the second electrode;
electrophoretic elements that are disposed between the first electrode and the second electrode and have a plurality of electrophoretic particles; and
the driving device for the electrooptical device according to claim 9.

13. An electrooptical device comprising:
the first electrode;
the second electrode;
electrophoretic elements that are disposed between the first electrode and the second electrode and have a plurality of electrophoretic particles; and
the driving device for the electrooptical device according to claim 10.

14. An electrooptical device comprising:
the first electrode;
the second electrode;
electrophoretic elements that are disposed between the first electrode and the second electrode and have a plurality of electrophoretic particles; and
the driving device for the electrooptical device according to claim 11.

15. An electronic device comprising the electrooptical device according to claim 12.

16. An electronic device comprising the electrooptical device according to claim 13.

17. An electronic device comprising the electrooptical device according to claim 14.
